(19) United States
(12) Patent Application Publication
(10) Pub. No.: US 2009/0303067 A1
(43) Pub. Date: Dec. 10, 2009

(54) METHOD AND APPARATUS FOR TRACKING POSITION

(75) Inventor: Ian Sharp, New South Wales (AU)

Correspondence Address: SUGHRUE MION, PLLC, 2100 PENNSYLVANIA AVENUE, N.W., SUITE 800, WASHINGTON, DC, 20037, US

(73) Assignee: COMMONWEALTH SCIENTIFIC AND INDUSTRIAL RESEARCH ORGANISATION, Campbell (AU)

(21) Appl. No.: 12/282,279

(22) PCT Filed: Mar. 8, 2007
(86) PCT No.: PCT/AU07/00282

§ 371 Date: Dec. 15, 2008

(30) Foreign Application Priority Data
Mar. 9, 2006 (AU) 2006901183

(51) Int. Cl. G08B 21/00; H04B 1/00

(52) U.S. Cl. 340/686.1; 375/130; 375/E01.001

(57) ABSTRACT

The present invention relates to a method and apparatus for tracking position of an object in a multipath environment (for example, inside a building) using radio signals.

In order to provide an accurate Time of Arrival (TOA) estimate in a multipath environment, a wide bandwidth signal (providing a sharp rise time pulse) is required. Only a limited bandwidth is available in the radio spectrum, however. Further, installations for position tracking which generate wide bandwidth signals require expensive and complex radios.

In the present invention, a number of narrow bandwidth signals are generated by a transmitter and combined together at a receiver to provide an effective wideband position location signal. Only relatively narrow bandwidth signals have to be transmitted, therefore, but accurate position can still be determined. Further, transmission of narrow bandwidth signals enables the use of relatively inexpensive radio transmitters.

### FIELD OF THE INVENTION

The present invention relates to a method and apparatus for tracking position of an object, and more particularly, but not exclusively, to a method and apparatus of processing a signal for providing time of arrival information to enable the position of an object to be tracked.

### BACKGROUND OF THE INVENTION

Radiolocation is an area of technology which uses radio signals to determine the location of a device. The scope of this technology is very wide, varying from short range (a few metres) to very long ranges associated with the navigation of spacecraft. In recent times the best-known system is the US Global Positioning System (GPS), which provides an accuracy of the order of a few metres (or better) anywhere on the surface of the earth, provided line-of-sight propagation exists to the associated satellites. However, indoor position location or position location in an urban environment is much less developed, mainly due to the difficult radio propagation conditions. Virtually all radio-based position location systems in practical use are based on determining the time-of-arrival (TOA) (or in some cases the phase) of a radio signal. Such systems effectively must estimate the time a “pulse” of radio energy is detected in the radio receiver. The accuracy of this determination depends on many factors, the most important of which include the signal bandwidth, the signal-to-noise (SNR), and the signal-to-interference (multipath) ratio. As a wideband system can result in the generation of a narrow pulse in the radio receiver, the accuracy of a system is essentially proportional to the signal bandwidth. For example, a bandwidth of (say) 1 MHz can result in a pulse with a rise time of about 1 microsecond. Under good SNR conditions a receiver can estimate the time of arrival to typically one percent of the rise time, or 10 nanoseconds (equivalent to about 3 metres. However, as the SNR drops the accuracy reduces, so that with an SNR of (say) 20 dB the accuracy is reduced to about 30 metres. Further, if there are multipath signals (as always occurs indoors), the received signal is a complex mixture of multiple scattered signals. As the scattered and reflected signals are delayed relative to the direct path, the accuracy of the determination of the time-of-arrival reduces to the order of these delays. However, if the signal bandwidth is sufficient to resolve each of the signals, then the TOA estimate can be based on the arrival of the first significant signal without any corruption from the other scattered signals.

The Applicant has therefore appreciated that accurate position location in a multipath environment requires wide bandwidth signals for TOA estimates. There are problems with the requirement for wide bandwidth, however. Firstly, only limited bandwidth is available in the radio spectrum. Secondly, generation of wide bandwidths requires complicated, power hungry and relatively expensive radios.

One wideband technology for providing accurate TOA data is being developed, and is called Ultra-Wideband (UWB). UWB occupies a bandwidth of about 3 to 10 GHz. However, such systems must severely limit the RF power radiated to avoid interfering with other radio systems, so that the range of a UWB position location system is typically limited to about 10 metres. Such systems require a large number of base stations to cover a typical indoor area, so that installations can be expensive and logistically difficult. Installations also require expensive radios to generate and receive the wideband signal.

### SUMMARY OF THE INVENTION

In accordance with a first aspect, the present invention provides a method of providing a signal for use in determining position information, comprising the steps of generating a plurality of signal portions, and transmitting the signal portions separately, wherein the signal portions are arranged to be combined with each other to produce a position signal which, if transmitted as a single signal would require a relatively wide bandwidth for transmission.

In one embodiment, each signal portion is transmitted over a relatively narrow bandwidth. This has the advantage that only relatively narrow bandwidths are required for transmitting a signal, but once the position location signal is synthesised by combining the signal portions an accurate position can be determined, roughly equivalent to a system using the relatively wideband signal. Transmission of narrow bandwidth signals enables the use of relatively inexpensive radio transmitters. For example, in one embodiment, single-chip radios which are currently available for other applications may be utilised. For example, radios which are utilised in Local Area Networks (LANs) may be used. Another advantage of this arrangement is that, because transmission of the signal portion occurs over relatively narrow bands, the transmission power does not have to be restrictively low (as with UWB) and reasonable accuracy can still be obtained at much longer ranges. A relatively low number of base stations may be required, therefore, in any position tracking system which may employ this method.

In one embodiment, the relatively wide bandwidth is between 500 MHz and 20 MHz and may be between 400 MHz and 100 MHz. In one embodiment the relatively wide bandwidth is between 300 MHz and 100 MHz.

In one embodiment, the relatively narrow bandwidth is less than 100 MHz, may be less than 20 MHz and may be less than 5 MHz.

In order to obtain the position signal, the signal portions must be combined in a receiving or position tracking apparatus. The signal portions when received are not synchronised in phase or time, so that, in an embodiment, a method is required to time and phase synchronise the signal portions before the “wideband” position signal can be synthesised.

In accordance with one embodiment, one or more reference signals are provided and transmitted with the signal portions, the reference signals facilitating establishing phase coherency of the signal portions so that the position signal can be synthesised.

In another embodiment establishing phase coherency and generation of the position signal may be carried out without reference signals.

Radio transmission requirements are defined by regulating authorities, in particular the Federal Communications Commission (FCC) in the United States. In one embodiment, in order to comply with regulatory requirements, the signal portions are generated and transmitted in the 2.4 GHz and the 5.8 GHz ISN bands. In one embodiment, signal modulation for transmission is by a combination of direct-sequence and frequency hopping spread-spectrum techniques, which is allowable under the FCC regulations.

In accordance with a second aspect the present invention provides a method of processing a signal for use in determining position information, comprising the steps of receiving signal portions transmitted in accordance with the first aspect of the invention, and combining the signal portions to produce the position signal.

In one embodiment the step of combining the signal portions includes the step of establishing phase coherency of the signal portions so that they can be combined. The step of establishing phase coherency may employ one or more reference signals generated as discussed above.

Alternatively, a correlation function may be generated for each signal portion and the peak of that correlation function then used as an estimate of the phase of the signal portion.

In accordance with a third aspect, the present invention provides a method of tracking position which utilises a position signal generated by the method of the second aspect of the present invention to determine the position of an object associated with the signal.

In accordance with a fourth aspect, the present invention provides an apparatus for providing a signal for use in determining position information, the apparatus comprising a generator arranged to generate a plurality of signal portions, and a transmitter for transmitting the signal portions separately, wherein the signal portions are arranged to be combined with each other to produce a position signal, which if transmitted as a single signal would require a relatively wide bandwidth for transmission.

In accordance with a fifth aspect, the present invention provides an apparatus for processing a signal for use in determining position information, the apparatus comprising a receiver for receiving signal portions transmitted by the apparatus of the fourth aspect of the present invention, and a signal synthesiser arranged to combine the signal portions to produce a position signal.

In accordance with a sixth aspect, the present invention provides a position tracking apparatus, the tracking apparatus including a position determinator which is arranged to utilise the signal provided by the apparatus of the fifth aspect of the invention in order to determine the position of an object associated with the position signal.

In accordance with a seventh aspect, the present invention provides a computer program including instructions for controlling a transmission apparatus to implement an apparatus in accordance with the fourth aspect of the present invention.

In accordance with an eighth aspect, the present invention provides a computer readable medium providing a computer program in accordance with the seventh aspect.

In accordance with a ninth aspect, the present invention provides a computer program including instructions for controlling a receiving apparatus to implement an apparatus in accordance with the fifth aspect of the present invention.

In accordance with a tenth aspect, the present invention provides a computer readable medium providing a computer program in accordance with the ninth aspect.

In accordance with an eleventh aspect, the present invention provides a computer program providing instructions for controlling a computing device to implement a position tracking apparatus in accordance with the sixth aspect of the present invention.

In accordance with a twelfth aspect, the present invention provides a computer readable medium providing a computer program in accordance with the eleventh aspect.

### BRIEF DESCRIPTION OF THE DRAWINGS

Features and advantages of the present invention will become apparent from the following description of an embodiment thereof, by way of example only, with reference to the accompanying drawings, in which:

FIG. 1 is a graph showing a typical example of a measured impulse for an indoor propagation path for a position signal (prior art);

FIG. 2 is a graph showing the standard deviation in a measured delay of a position signal in an indoor environment as a function of the nominal resolution (prior art);

FIG. 3 is an example spectrum of a reference signal generated in accordance with an embodiment of the present invention;

FIG. 4 is a block diagram of a receiver arrangement in accordance with an embodiment of the present invention; and

FIG. 5 is a block diagram of a transmitter arrangement in accordance with an embodiment of the present invention.

### DETAILED DESCRIPTION OF EMBODIMENT

Before describing the preferred embodiment, the requirements for accurate time-of-arrival (TOA) estimates and signal bandwidths will be investigated further.

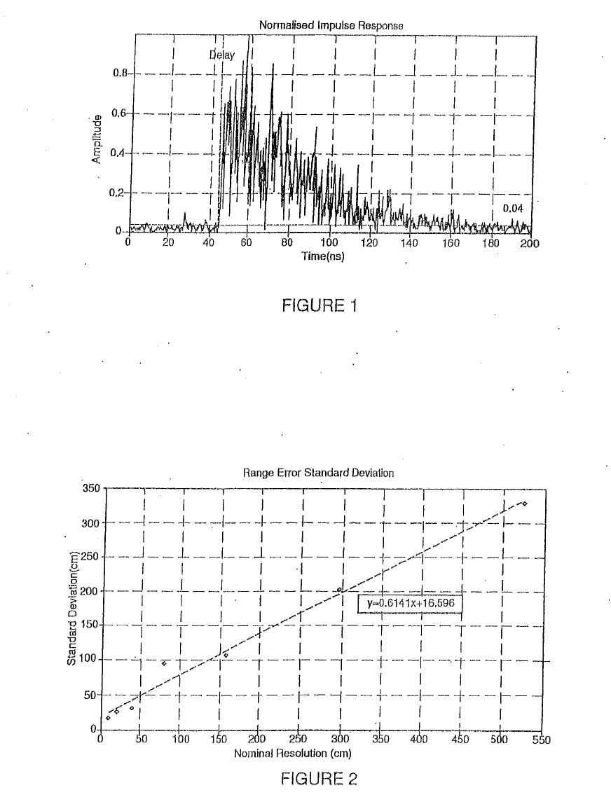

As discussed in the preamble, if the signal bandwidth is sufficient to resolve each of the signals within a multipath environment, then TOA estimate can be based on the arrival of the first significant signal without any corruption from the other scattered signals. In the case of an indoor none line-of-sight environment the scattered signals delays are typically from 1 metre or greater (equivalent to about 3 nanoseconds), so that the required bandwidth to resolve the multipath signals is of the order of 300 MHz or greater (see FIG. 1, which shows an example of the measurement to the TOA pulse with a bandwidth of 3 GHz (or a resolution of about 0.3 nanoseconds)). Observe that the arrival time is determined by the first significant signal above the background noise, and that the delayed signals do not affect the measurement provided the delay of other scattered signals is greater than the pulse rise time.

In FIG. 1, the data are normalised to a peak amplitude of unity. The minimum signal threshold is set at 0.04 (equivalent to a signal-to-noise ratio of 28 dB), but the actual threshold used depends on the measured noise level. The SNR of this pulse is calculated to be 36 dB, based on the RMS noise level. The “Delay” shown is based on the geometric straight-line path from the transmitter to the receiver. Based on the first significant signal, it can be observed that there is a small error of a few nanoseconds in the estimation of the straight-line arrival time.

The determination of the position from TOA data is relatively simple, if it is assumed that the radio signal travels in straight lines at the speed of light. However, usually the time of transmission at the transmitter is not known at the receiver, so that in practice systems such as GPS use time-difference data between two receivers which are synchronised in time. This procedure effectively removes any unknown delays in the transmitter and the receiver, so that the position accuracy depends mainly in the variation in the TOA rather than the mean delay errors. The standard deviation in the measured delay in an indoor environment as a function of the nominal resolution (reciprocal of the radio bandwidth expressed as a distance using the speed of propagation) is shown in FIG. 2. As can be observed the accuracy is a linear function of the nominal resolution. Thus for example, to have a ranging error of 1 metre requires a nominal resolution of about 1.5 metres (or a bandwidth of 200 MHz). Note also that even with a small nominal resolution (very wide bandwidth) there is a limiting accuracy of about 20 centimetres.

The generation of wideband pulses with wide bandwidths is one approach to obtaining accurate TOA data (as discussed above). One such technology being developed is called Ultra-Wideband (UWB), which occupies a bandwidth of about 3-10 GHz. However, such systems must severely limit the RF power radiated to avoid interfering with other radio systems, so that the range of such UWB position location systems is typically limited to about 10 metres, but with an accuracy (as defined above) of about 20 centimetres. Such systems require a large number of base stations to cover a typical building, so that installations can be expensive and logistically difficult. As an alternative, the ISM bands could be used. The 2.4 GHz ISM band has a bandwidth of 80 MHz, and the 5.8 GHz band 150 MHz (in Australia). Based on FIG. 2 the associated ranging accuracy are respectively 2.25 metres and 1.3 metres. If the two bands are combined, the total bandwidth is 230 MHz, which has an estimated ranging accuracy of 1 metre. Further, the allowable transmitter power in these bands is up to 4 watts, so that the potential range indoors is large. Calculations show that a typical such wideband system with a 1 milliwatt transmitter has a range of at least 30 metres indoors under non line-of-sight propagation, but much greater ranges are possible with the higher transmitter powers defined above, or less restrictive propagation conditions such as in open-plan offices. Thus potentially a system based on the ISM bands can simultaneously achieve both a 1 metre accuracy and at least a 30 metres range.

While the present embodiment is based on the science of signal modulation and signal processing techniques, any practical system must operate under the rules specified by regulatory authorities. As the US requirements are typically the benchmark used in most countries, the following paragraphs provide an outline of the requirements for the 2.4/5.8 ISM bands.

A summary of the main FCC requirements is as follows:
1. The signal protocol of any practical system must be a form of spread-spectrum, either direct-sequence or frequency hopping. A hybrid system is also acceptable.
2. Frequency hopping systems shall have hopping channel carrier frequencies separated by a minimum of 25 kHz or the 20 dB bandwidth of the hopping channel, whichever is greater. The maximum 20 dB bandwidth of the hopping channel is 1 MHz.
3. Frequency hopping systems shall use at least 75 hopping frequencies. The average time of occupancy on any frequency shall not be greater than 0.4 seconds within a 30 second period. Each frequency must be used equally on the average.
4. The maximum peak output power of an intentional radiator shall not exceed 1 watt.
5. For direct-sequence systems, the minimum 6 dB bandwidth shall be at least 500 kHz.
6. The processing gain of a direct-sequence system shall be at least 10 dB. The processing gain represents the improvement to the signal-to-noise ratio at the output of the receiver, after filtering to the information bandwidth.
7. For direct-sequence systems, the peak power spectral density conducted from the intentional radiator to the antenna shall not be greater than 8 dBm in any 3 kHz band during any time interval of continuous transmission.
8. In any 100 kHz bandwidth outside the frequency band in which the spread-spectrum intentional radiator is operating, the radio frequency power that is produced by the intentional radiator shall be at least 20 dB below that in a 100 kHz bandwidth within the band that contains the highest level of the desired power, based on either an RF conducted or a radiated measurement.

The basic concept behind the regulations in the ISM band is that some form of spread-spectrum modulation with associated processing gain is required. The processing gain is broadly defined as the ratio of the output SNR to the input SNR. For direct-sequence spread-spectrum modulation the process gain is simply the length of the pn-code in chips. For frequency-hopping spread-spectrum modulation the process gain is the ratio of the total RF bandwidth to the bandwidth of the hopped channel. In the special case where the channels abut one another the processing gain is equal to the number of hopping channels. Thus the process gain for frequency hopping spread-spectrum systems operating in the ISM band must be at least 75, or about 19 dB. The FCC rules also refer to the pseudo-random frequency-hopping. Such a random scheme is not essential for achieving the processing gain in other systems simultaneously using the ISM band, but typically is required for simultaneous multiple use within a given frequency-hopping system. Such systems are usually referred to as code division multiple access (CDMA). However, the proposed embodiment described in this document does not use this type of multiple access, but rather uses time division multiple access (TDMA). Thus all modules in the proposed embodiment transmit using the same modulation, with the same direct-sequence spread-spectrum pn-code and the same frequency-hopping sequence, but at different times.

A detailed description of an embodiment of the present invention will now be given. Note that while the description is based on a particular implementation for the 2.4 and 5.8 GHz ISM bands, the invention is generic, and thus could be applied to other radio systems.

In this embodiment, we sub-divide a wide bandwidth generated by direct sequence spread-spectrum signal into a number of the sub-bands much less than the total bandwidth. An advantage of this embodiment is that narrower band radios are easier to design, and the “digital” signal processing can be performed at much lower clock frequencies. Indeed, such radios already exist, namely dual-band radios (2.4/5.8 GHz) for 802.11 applications. Thus instead of transmitting the wideband signal at one time, the signal is transmitted sequentially, one sub-band at a time. This task is simple for the transmitter, but reconstructing the wideband signal in the receiver is difficult due to the need for phase coherency across the total band. If phase coherency and adequate time alignment can be achieved, then the reconstructed signal can be input to a correlator to generate the correlation function in the time domain (the “pulse” required for TOA estimation). Note that each sub-band will have the characteristics similar to a pseudo-random code, and thus as far as the FCC rules are concerned the transmission can be classed as a direct-sequence spread-spectrum signal.

The main problem with reconstructing the wideband signal is that the receiver cannot maintain phase coherence as the carrier frequency is changed for each sub-band. While each sub-band is internally phase coherent, the phase between the bands will be essentially random. Thus some method is required to determine the relative phase of the carrier used to modulate the direct-sequence spread-spectrum signal. The spread-spectrum signal itself cannot be used as a phase reference, as the signal is typically low in amplitude, and buried in noise. Thus some other phase reference must be used.

For this embodiment, the proposed phase reference is a separate frequency-hopping signal which is transmitted simultaneously with each sub-band. A simple implementation would use one such signal (called a “pilot” signal in this embodiment). This signal would be transmitted with relatively high power (say of the order of 25 percent of the total), but as the signal is narrowband, the spectral line will be much stronger than the spread-spectrum signal at the same frequency. Because of the effective narrow band of the pilot signal, the receiver output SNR will be high, allowing the receiver to estimate the phase of the RF carrier. As the spread-spectrum signal will be modulated by the same carrier signal, the phase of the spread-spectrum signal will thus also be determined. As each pilot will be transmitted with the same phase (or more likely a known pseudo-random phase pattern), the sub-band spread-spectrum signals can be reconstructed with approximate phase coherency. The penalty for this procedure is a slight reduction in the power of the spread-spectrum signal (some power is allocated to the pilot signal), and the corruption of the spread-spectrum signal at the pilot signal frequency. However, such corruption of the spread-spectrum is minimal, if the pilot signal is first nulled out (in the frequency domain—namely a notch filter) before being applied to the correlator. The reduction in power applied to the spread-spectrum signal results in a slight reduction in the correlator process gain, typically by about 1-2 dB. As the nominal process gain will typically be high (greater than 30 dB), this reduction in process gain is of minimal importance to the overall system performance.

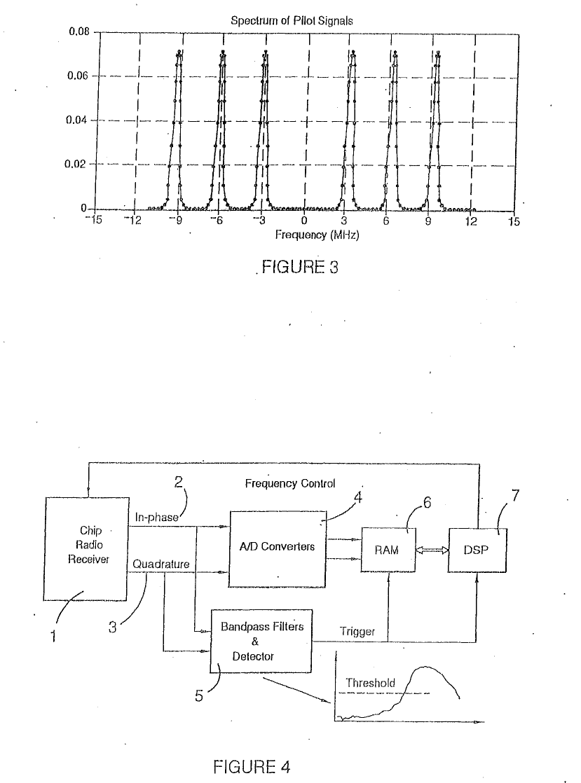

However, the simple single pilot signal system described may not be practical. Firstly, in a multipath environment the signal can be subjected to signal fades at some frequencies across the band. This effect can be minimised by using more than one pilot signal, so that the probability of simultaneous fades across the band is greatly reduced. However, the FCC rules proscribe the use of multiple pilot signals, as these signals are interpreted as frequency-hopping signals, only one of which can be present at a time. Thus for multiple pilot signals, each pilot can be transmitted only for a fraction of the time allocated for the transmission of the direct-sequence spread-spectrum signal. As a consequence, the pilot signal spectrum is no longer effectively a single frequency but is spread out somewhat. This spreading corrupts more of the direct-sequence spectrum as the number of pilots increases, thus placing a practical limit on the number of pilot signals per sub-channel. For example, in FIG. 3, the spectrum of 6 pilots is shown, with a bandwidth of about 1.2 MHz per pilot. Note that the FCC specification requires that the −20 dB bandwidth of the pilot be less than 1 MHz, which is approximately true for this signal. Thus the total signal corrupted is 7.2 MHz in this case, and thus the uncorrupted signal has a spectral bandwidth of about 18 MHz. The reduction in process gain is thus 10 log ( 17/25) or −1.4 dB. Thus the effect on the correlator is relatively minor. The FCC rules state that the total number of frequency-hopping frequencies must not be less than 75, so that a minimum of 13 such sub-channels must be transmitted in this case, each with different pilot signal frequencies.

The pilot method of obtaining phase coherency is particularly attractive, as the signal processing required is minimal in typical receiver architectures. To obtain the wideband correlation function, the most computationally efficient method is via the use of Fast Fourier Transforms (FFT). In this method, the spectrum of each sub-band is calculated, phase aligned, and the wideband spectrum thus constructed. By multiplying this reconstructed spectrum with a known copy of the wideband signal spectrum, and computing the inverse FFT, the correlation function can be determined. As this method requires the spectrum of the signal to be determined, the determination of the phase of the pilot signals is a trivial extension of the processing.

An alternative approach that does not use pilot signals is also possible, but with considerable increase in the required signal processing. In this technique the sub-band correlation functions are all computed by the same method as described above for the wideband signal. From these correlation functions, the phase of the peak of the correlation function is an estimate of the phase of the sub-band RF signal. While this method does not require pilot signals, the considerable extra processing required may make this method less attractive. Thus a system might include pilot signals, and would leave the choice of signal processing to the receiver designer. A system which does not include pilot signals is an option.

This section outlines the signal processing required in the receiver in this embodiment, to estimate the TOA from the transmissions from the transmitter. The transmitter signals will consist of hybrid direct-sequence and frequency hopping signals as outlined above. The exact number of sub-channels, pilot signals, channel bandwidths and other parameters will depend on the details of each system, but in all cases the characteristics must comply with the FCC rules. In addition to these signals, additional features are required to allow the receiver to detect the transmissions, and then process the sub-channel data to reconstruct the complete wideband spectrum. A description of a practical implementation is given in the following paragraphs.

The basic requirement is that mobile units will transmit the signal protocol each time a position fix will be required. These signals will be received at base stations, which will determine the time-of-arrival. It is assumed that these transmissions occur relatively slowly, say a few times a second at most, thus obtaining a position fix a few times a second. To simplify the mobile device design, it will further be assumed that these transmissions occur pseudo-randomly, so that no time synchronisation is required in the mobile unit. This design has a small probability of signal transmission clashes, but the simple implementation without time synchronisation makes this method attractive.

The following description of the signal processing is typical of an implementation, but actual systems using the key concepts of the embodiment may be different in detail, but overall similar in concept. For this illustrative example, the 5.8 GHz ISM band will be used, with a bandwidth of 150 MHz. This band will be sub-divided into eight sub-channels of approximately 20 MHz radio bandwidth, or about 10 MHz baseband output (in-phase and quadrature). These specifications of sub-channel bandwidth are typical of the chip radios used in 802.11a/b/g wireless LAN systems. The assumed sample rate for both the in phase and quadrature channels is 25 Msps. The direct sequence signal is assumed to be 2047 chips in length, with a chip rate of 100 Mchips per second, filtered to be constrained to the 150 MHz ISM bandwidth. Thus the period of the pn-code is 20.47 microseconds, which is one frame. The frequency-hopping pilot tones will be six in number per frame, each transmitting for about 3.4 microseconds.

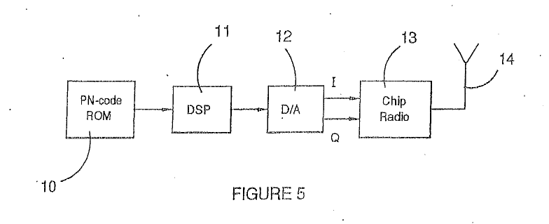

A block diagram of a possible implementation of the receiver is shown in FIG. 4. The chip radio 1 outputs baseband In-phase 2 and Quadrature 3 signals which are digitised by two A/D converters 4. The I/Q outputs are also feed to two bandpass filters and two detectors 5, the outputs of which are summed. The output from the detectors is low, except when the preamble pilot signal is present. If this signal exceeds a threshold level, an output trigger signal is generated, which causes the A/D converter outputs to be saved in a RAM 6. The RAM data are later processed by a DSP 7. The DSP 7 processes the logged data to determine the time-of-arrival. The trigger signal is also used by the DSP 7 to change the frequency of the radio receiver, thus scanning though the sub-channels.

With reference to FIG. 4, in this embodiment, the base station signal processing for signal acquisition and determination of the time-of-arrival is summarised as follows:
1. The first frame of data will consist of a pilot signal at a unique frequency known to the receiver. The receiver hardware shall have a filter tuned to this frequency. The small bandwidth of the filter means that the output SNR is similar to that associated with the correlator described in later paragraphs. The bandpass filter may be analog or digital.
2. The output from the filter will trigger the sub-channel data acquisition process. Because of the complex signal processing, the typical implementation will involve the logging of the data from the receiver into a suitable RAM for later processing. The data for both the in-phase and quadrature channels are stored in the RAM for later processing. The total number of samples per frame is about 1K.
3. After each sub-channel transmission the transmitter will change the frequency. The receiver infers this time based on the original trigger signal and the known length of a frame. The period allowed for the change in frequency will typically be the same as that required to transmit the sub-channel data, namely 20.47 microseconds in this case. During this period, the radio receiver frequency synthesizer must obtain a phase-stable signal. Tests show that actual radio hardware can meet this requirement.
4. After the transmission of all the sub-channels, the receiver will have logged all the data, including the periods of changing frequency. The receiver now must determine the start of each section of the data corresponding to the sub-channel transmissions. The start of each frame of data is approximately known from the original trigger signal to an accuracy of about ±2 microseconds (or ±50 samples) at the limiting SNR. This time alignment is sufficiently accurate to allow a correlation with a reduction in output of at most 1 dB with the maximum misalignment. The correlation process will determine a complete correlation diagram (or correlogram), which gives the correlation amplitude as a function of correlation time. The nominal position of the peak should be at the t=0 point, with any time offset being related to the error in the initial estimation of the time of the start of the frame. The position of the peak can be detected to an accuracy of about ±2 samples; this error has negligible effect on the following signal processing.
5. Having determined accurately the location of the first frame of data, the other frames of data can be inferred from the known signal protocol and the frame time length. For this illustrative example, a total of eight frames of data must be processed. Each frame will have 512 complex data samples.
6. The spectrum of each frame of data is calculated using a Fast Fourier Transform (FFT). The spectrum will contain the six pilot signals plus the sub-channel component of the wideband signal. The pilot signals will be at known frequencies and known pseudo-random phase offsets. The associated frequency bins in the FFT are used to determine the complex signal of the pilots, which are then summed (after phase rotation by the known pseudo-random phase inserted at the transmitter). The phase of this cumulated signal is then used as the phase reference for the frame.
7. The spectrum of each frame is corrected by the pilot phase, so that all the sub-channel spectra are approximately phase coherent. Additionally the spectral components near the pilot frequency are nulled out in each spectrum of the frame. These spectral data are then concatenated to provide an estimate of the broadband spectrum.
8. The correlogram c(τ) is then calculated by performing the following operation:

c(τ)=F⁻¹└RX(f)PN(f)*┘

where RX(f) is the estimated broadband signal calculated in paragraph (7) above, and PN(f) is the (known transmitted) spectrum of the wideband pseudo-random code.
9. The time-of-arrival is typically estimated from the correlogram c(τ). For example, the TOA can be estimated by an algorithm which processes the leading edge of the correlogram, thus minimising the effects of multipath interference. For this illustrative example with a chip period of 10 nanoseconds, the nominal correlogram has a rising edge of one chip. Typically the TOA can be estimated to an accuracy of about 10 percent of chip period, or about 1 nanosecond.
10. The TOA estimate is measured relative to a local clock. This clock is accurately synchronised in frequency with other units (base stations) in the network, but time synchronisation is not necessary. This frequency synchronisation can be obtained by suitable processing of the TOA estimate itself to an accuracy of about one part per billion, and thus no additional signal processing is required for frequency synchronisation in the receiver. The local clock is used to generate the local frame and control signals for the A/D converters. Samples from the A/D converter are time stamped relative to the local frame, so that the measured TOA is also relative to local frame clock. For position determination based on the TOA data, the phase of the local clock must be determined in addition to the position. The details of this process are not relevant to this embodiment.

A transmitter arrangement for this embodiment may be quite simple, including a digital signal processor, a digital to analogue converter and a radio transmitter. The digital signal processor is arranged to generate the signal portions for transmission.

A embodiment of the transmitter arrangement will now be described with reference to FIG. 5. FIG. 5 is a block diagram of a transmitter arrangement in accordance with an embodiment of the present invention. A read-only memory (ROM) 10 provides the pseudo-random (PM) code to be transmitted. Only part of the code is transmitted at a time in each sub-channel. A Digital Signal Processor (DSP) 11 organises the data to be transmitted, and outputs the digital data to the digital analogue converter (D/A) 12. The DSP 11 also controls the operation of a radio 13.

The dual-channel D/A 12 generates the in-phase (I) and quadrature (Q) analogue signals which define what the radio transmits. The chip radio 13 (with attached antenna 14) provides radio frequency transmissions modulated by input from the D/A converters 12. The DSP 11 defines the frequency of the transmissions, one for each sub-channel.

In the above embodiment the signal portions are transmitted sequentially. They need not, however, be transmitted in any particular order. They may be transmitted out of sequence, for example, and reassembled at the receiver. Other embodiments, therefore may, transmit the signal portions other than sequentially.

In the above embodiment, all the signal portions are transmitted. In other embodiments, it may not be necessary to transmit all the signal portions. It may be sufficient to transmit only some of the signal portions. The portion signal may be synthesised without all the component signal portions, in some circumstances.

The method and apparatus discussed above may generate signals which can be used to provide position information in any number of tracking applications. For example, for tracking position of individuals carrying transmitters/receivers in an urban environment within a building, or for tracking the position of any object.

Although the above-described embodiment operates over the 2.4 and 5.8 GHz ISM bands, it will be appreciated that in the invention is not limited to operation within these bandwidths and that other bandwidth operation could be implemented, depending upon radio regulations at the time and within the particular jurisdiction.

The transmitter and receiver arrangements are not limited to the particular block arrangements illustrated in FIGS. 4 and 5. Any appropriate configuration that applies the functionality of the invention may be utilised.

One implementation of the embodiment may be carried out by appropriate software programming of existing radios systems (such as radio sets which are used in wireless LANs) without any additional hardware. This concept makes the upgrading of existing technology relatively simple, while simultaneously obtaining ranges comparable with existing data-only transmission systems, but with superior positional accuracy when compared with existing techniques.

It will be appreciated by persons skilled in the art that numerous variations and/or modifications may be made to the invention as shown in the specific embodiments without departing from the spirit or scope of the invention as broadly described. The present embodiments are, therefore to be considered in all respects as illustrative and restrictive.

1. A method of providing a signal for use in determining position information, comprising the steps of generating a plurality of signal portions, and transmitting the signal portions separately, wherein the signal portions are arranged to be combined with each other to produce a position signal which, if transmitted as a single signal would require a relatively wide bandwidth for transmission.

2. A method in accordance with claim 1, wherein each signal portion is transmitted over a relatively narrow bandwidth.

3. A method in accordance with claim 1, including the further step of generating and transmitting a reference signal, the reference signal being arranged to be used to facilitate combination of the signal portions to produce the position signal.

4. A method in accordance with claim 3, wherein a plurality of reference signals are generated and transmitted.

5. A method in accordance with claim 1, wherein the signal portions are transmitted within the 2.4 GHz and the 5.8 GHz ISM band (as defined by the Federal Communications Commission (USA)).

6. A method in accordance with claim 5, wherein signal modulation utilised for transmission of the signal portions is a combination of direct-sequence spread-spectrum and frequency hopping.

7. A method of processing a signal for use in determining position information, comprising the steps of receiving signal portions transmitted in accordance with claim 1, and combining the signal portions to produce the position signal.

8. A method in accordance with claim 7, wherein the step of combining the signal portions includes the step of establishing phase coherency of the signal portions so that they can be combined.

9. A method in accordance with claim 8, wherein the step of establishing phase coherency employs a reference signal which is received in addition to the signal portions and which is arranged to be utilised to provide a phase reference.

10. A method in accordance with claim 9, wherein a plurality of reference signals are received and employed to establish phase coherency.

11. A method in accordance with claim 8, wherein the step of establishing phase coherency of the signal portions comprises the step of computing correlation functions for each of the signal portions, determining the phase of the peak of each correlation function and using the determination to estimate the phase of each signal portion.

12. A method of tracking position which utilises a position signal generated by the method of claim 7 to determine the position of an object associated with the signal.

13. An apparatus for providing a signal for use in determining position information, the apparatus comprising a generator arranged to generate a plurality of signal portions, and a transmitter for transmitting the signal portions separately, wherein the signal portions are arranged to be combined with each other to produce a position signal, which, if transmitted as a single signal would require a relatively wide bandwidth for transmission.

14. An apparatus in accordance with claim 13, wherein the transmitter is arranged to transmit each signal portion over a relatively narrow bandwidth.

15. An apparatus in accordance with claim 13, wherein the generator is also arranged to generate a reference signal, and the transmitter is arranged to transmit the reference signal, the reference signal being arranged to be used to facilitate combining of the signal portions.

16. An apparatus in accordance with claim 15, wherein the generator and transmitter are arranged to generate and transmit a plurality of reference signals.

17. An apparatus in accordance with claim 13, wherein the transmitter is arranged to transmit the signal portions within the 2.4 GHz and 5.8 GHz ISM band (as defined by the Federal Communications Commission (USA)).

18. An apparatus in accordance with claim 17, wherein the transmitter is arranged to utilise signal modulation for transmission of the signal portions which is a combination of direct-sequence spread spectrum and frequency hopping.

19. An apparatus for processing a signal for use in determining position information, the apparatus comprising a receiver for receiving signal portions transmitted by the apparatus of claim 13, and a signal synthesiser arranged to combine the signal portions to produce a position signal.

20. An apparatus in accordance with claim 19, wherein the combiner is arranged to establish phase coherency of the signal portions so that they can be combined.

21. An apparatus in accordance with claim 20, wherein the combiner is arranged to employ a reference signal, the reference signal being arranged to be used to facilitate establishing phase coherency of the signal portions.

22. An apparatus in accordance with claim 21, wherein the combiner employs a plurality of reference signals.

23. An apparatus in accordance with claim 19, wherein the combiner is arranged to obtain a correlation function for each signal portion using Fast Fourier Transforms or other signal processing techniques, determine the phase of the peak of the correlation function and utilise this as an estimate of the phase of each signal portion.

24. A position tracking apparatus, the tracking apparatus including a position determinator which is arranged to utilise the signal provided by the apparatus of claim 19 in order to determine the position of an object associated with the position signal.

25. A computer programme including instructions for controlling a transmission apparatus to implement an apparatus in accordance with claim 13.

26. A computer programme in accordance with claim 25, wherein the transmission apparatus includes a single-chip radio.

27. A computer-readable medium, including a computer programme in accordance with claim 24.

28. A computer programme including instructions for controlling a receiving apparatus to implement an apparatus in accordance with claim 19.

29. A computer-readable medium providing a computer programme in accordance with claim 26.

30. A computer programme providing instructions for controlling a computing device to implement a position tracking apparatus in accordance with claim 24.

31. A computer-readable medium providing a computer programme in accordance with claim 30.

32. A system for processing a signal for use in determining position information, the system comprising an apparatus for providing a signal for use in determining position information, the apparatus comprising a generator arranged to generate a plurality of signal portions, and a transmitter for transmitting the signal portions separately wherein the signal portions are arranged to be combined with each other to produce a position signal, which, if transmitted as a single signal would require a relatively wide bandwidth for transmission and an apparatus for processing a signal for use in determining position information, the apparatus comprising a receiver for receiving signal portions transmitted by the apparatus of claim 13, and a signal synthesiser arranged to combine the signal portions to produce a position signal.
